(19) United States
(12) Patent Application Publication
(10) Pub. No.: US 2012/0143617 A1
(43) Pub. Date: Jun. 7, 2012

(54) Systems and Methods for Clinical Trial Documenting Using a Mobile Communications Device

(75) Inventors: Robert Dwight Connors, Sugar Land, TX (US); Charles Russell White, Pollok, TX (US)

(73) Assignee: TAD Clinical Research

(21) Appl. No.: 12/962,413

(22) Filed: Dec. 7, 2010

(51) Int. Cl. G06Q 50/00; G06Q 10/00

(52) U.S. Cl. 705/2

(57) ABSTRACT

Systems and methods presented herein may involve documenting clinical trials through use of a mobile communications device, such as a camera phone. Using the mobile communications device, the participant may record video of themselves administering a health intervention that is the subject of the clinical trial and/or report serious adverse events that occur. The video clips may be sent to a documentation server for documentation. The documentation server may also route serious adverse event notifications to a plurality of locations, such as the doctor's office, the study center, and/or the pharmaceutical company that developed the health intervention being tested.

### DESCRIPTION OF THE EMBODIMENTS

1. Field of the Embodiments

The embodiments relate generally to computer-implemented technologies for facilitating clinical trial compliance, and, more specifically, to systems and methods for gathering clinical trial documentation via mobile communications devices.

2. Background

Clinical trials are conducted to collect safety and effectiveness data for various health interventions (e.g., health-related products or methods, drugs, medical devices, and therapy protocols). Clinical trials can span multiple phases and can vary in size between a single study center in one country to multicenter trials in multiple countries. Additionally, the number of participants involved in the clinical trial can vary between a few people and thousands of people. During the clinical trial, study centers may recruit volunteers meeting particular characteristics and collect data from the participants to track the effects of administering of the health intervention (i.e., the tested pharmaceutical, medical device, etc). Example sponsor entities include governmental organizations, pharmaceutical companies, and biotechnology companies, but is not limited to these entities.

The accuracy of a clinical trial depends on, among other things, ensuring that the participant complies with the requirements of the clinical trial. One such requirement is that the participant administers (e.g., consumes or injects) the required amounts of the health intervention (e.g., studied medication) at scheduled intervals. In many clinical trials, it is not possible for a supervisory individual (e.g., study center employee) to administer each dose of the tested medication (or other health intervention). Additionally, participants have been known to report compliance when they have, in fact, not fully complied. This can be detected, for example, when a participant reports 100% compliance yet shows no detectable test medication levels in their PK samples. Other times, the noncompliance goes completely undetected.

As a result, the FDA has requested that study centers monitor participants' administration of health interventions (e.g., drugs or medical devices) during clinical trials. This requirement has added considerable inconvenience to the clinical trial process. Currently, at least one study administrator watches live as each participant administers the medical intervention (e.g., a dosage of medication), and must do so for each administration by each participant. This process can be cumbersome for both participants and study centers, especially when there are thousands of participants and/or varying dosage schedules involved. Sometimes, no one from the study center is available to personally witness a participant's compliance with clinical trial requirements, which can result in the participant skipping the dosage or, at a minimum, unverifiable results. This can compromise both the validity and audit ability of the clinical trial.

During clinical trials, study centers also document any serious adverse events (SAEs) that arise in order to determine safety and possible adverse reactions related to the tested health intervention. The study sites require the participant to report any SAE to them as soon as it occurs. Additionally, sponsor drug companies may require the study center to report any SAE to the company within 24 hours. Further complicating matters, the FDA guidelines require drug companies to report SAEs (e.g., transmitting a final SAE report) to the FDA within 15 days. Often, one or more of these deadlines can be missed because of the required chain of phone calls or e-mail from all the involved parties. The participant's failure to rapidly report the SAE (e.g., within 24 hours) can also be problematic.

In addition to witnessing a participant's administration of the study health intervention and the timely reporting of SAEs, sponsor entities also may require each participant to keep a diary of various events. Generally, the diary serves to document events that yield helpful information in judging the safety and/or effectiveness of the health intervention, or the reliability of the test as it pertains to each participant.

Therefore, a need exists for a system that provides increased flexibility, visibility, and audit ability of the administration of health interventions in clinical trials, as well as increased ease in reporting SAEs.

Accordingly, systems and methods are provided herein for using a mobile communications device to document clinical trial compliance, including the administration of health interventions and the reporting of SAEs.

### SUMMARY

Embodiments described herein include systems and methods for documenting clinical trial compliance using a mobile communications device. In one embodiment, a system for facilitating clinical trial documentation comprises a database including a non-transitory storage medium for storing clinical trial data. The system also includes a processor in communication with the database, the processor performing stages. These stages include receiving a video clip from a mobile communications device, and associating the video clip with a particular participant from amongst a plurality of participants based on information received from the mobile communications device. Additionally, the processor may associate the video clip with a particular administration from amongst a plurality of administrations of a health intervention in the clinical trial. The video clip may therefore be stored in the database in association with the particular participant and the particular administration. This can allow a supervisor user to review the video clips at a later time, and satisfy FDA initiatives to monitor clinical trial compliance.

Additionally, the processor may receive, from the mobile communications device, a notification of a serious adverse event, and store the notification in the database. Additionally, the processor may retrieve from the database a plurality of destinations for receiving the notification of the serious adverse event, and send the notification of the serious adverse event to the plurality of entities. For example, these entities may include a study center, doctor's office, sponsor pharmaceutical company, and/or the Federal Drug Administration.

Another embodiment described herein includes a non-transitory computer-readable medium containing instructions that, when executed by a processor on a mobile communications device, cause the mobile communications device to perform steps. The steps include displaying, on a screen of the mobile communications device a first option to record video of an administration of a health intervention as part of a clinical trial, a second option to report a serious adverse event related to the clinical trial, and a third option to answer questions related to the clinical trial. Additionally, the mobile communications device receives a selection of the first option and records a video clip of the administration of the health intervention. The mobile communications device also connects to a documentation server that stores a plurality of video clips from a plurality of participants in the clinical trial, and transmits the video clip to the documentation server.

In another embodiment, the non-transitory computer-readable medium contains instructions that, when executed by the processor, cause the mobile communications device to display an option to report a serious adverse event. The mobile communications device is also caused to receive a selection of the option to report the serious adverse event, and report the serious adverse event to the documentation server. Such reporting may includes data indicating the serious adverse event and an identifier (e.g., phone number and/or password) that allows the documentation server to report the serious adverse event to a plurality of sources.

It is to be understood that both the foregoing general description and the following detailed description are exemplary and explanatory only and are not restrictive of the embodiments, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an exemplary illustration of a system that facilitates clinical trial compliance, in accordance with an embodiment;

FIG. 2 is an exemplary illustration of screens displayed on mobile communications devices for facilitating clinical trial compliance, in accordance with an embodiment;

FIGS. 3A-B are exemplary flow charts with non-exhaustive listings of steps that may be performed by a mobile communications device, in accordance with an embodiment;

FIG. 4 is an exemplary flow chart with a non-exhaustive listing of steps that may be performed by a documentation server in handling clinical trial documentation received from the mobile communications device, in accordance with an embodiment; and

FIG. 5 is an exemplary flow chart with a non-exhaustive listing of steps that may be performed between the mobile communications device and the documentation server to record and store video clips of a participant administering a health intervention, in accordance with an embodiment.

### DESCRIPTION OF THE EMBODIMENTS

Reference will now be made in detail to the present exemplary embodiments, including examples illustrated in the accompanying drawings. Wherever possible, the same reference numbers will be used throughout the drawings to refer to the same or like parts.

Exemplary embodiments herein allow a participant of a clinical trial to use a mobile communications device (e.g., cell phone) to comply with the documentation requirements of the clinical trial. For example, each time the participant administers the tested health intervention (e.g., consumes test medicine or uses a medical device), the participant can use the mobile communications device to record themselves taking the medicine, and the video clip can be wirelessly uploaded to a remote database (e.g., documentation server) for storage. This allows the participant to administer the health intervention (e.g., take a dose of the test medicine) without a study supervisor witnessing it live. Instead, a study supervisor can view the video clip at a later time to verify compliance, and/or an audit can be performed to confirm compliance by viewing large numbers of video clips (e.g., all the doses) at one time.

Similarly, the participant can report a serious adverse event (“SAE”) related to the clinical trial by selecting an option that is displayed on the mobile communications device. The mobile communications device will notify the documentation server of the SAE. The documentation server then may notify a plurality of entities of the occurrence of the SAE. These notified entities may include, for example, the clinical trial study center, the sponsor pharmaceutical company, the Federal Drug Administration, and/or the participant's doctor's office.

Providing this functionality on a mobile communications device, such as the participant's mobile phone, may increase the convenience and likelihood of complying with the clinical trial requirements. Systems and methods herein may also streamline the auditing process of a clinical trial.

The term clinical trial is used as indicated above, but can also apply to any other scenario wherein a doctor monitors the treatment of one or more of his patients using systems, methods, and/or devices described herein. In such a scenario, the term “participant” can include any patient under care of the doctor. As another example, an embodiment may allow a nurse to monitor a patient's use of a colostomy bag, and train the patient to use the bag properly by providing feedback after watching the patient administer the health administration (e.g., use the colostomy bag). Conversely, depending on the requirements of the particular clinical trial, a participant need not necessarily be ill in order to participate in the clinical trial.

Additionally, although the taking of study medication may be discussed in examples herein for convenience, it is understood that embodiments described herein can apply to the testing of any health intervention, such as the use of medical instruments, dosage schedules for existing medications, new medical delivery device, or any pharmaceutical substance or health regimen.

Embodiments herein include mobile communications devices, computer-implemented methods, tangible non-transitory computer-readable mediums, and systems. The computer-implemented methods may be executed, for example, by a processor that executes instructions stored on a non-transitory computer-readable storage medium. Similarly, a system described herein may include a processor and a memory, the memory being a non-transitory computer-readable storage medium. As used herein, a non-transitory computer-readable storage medium refers to any type of physical memory on which information or data readable by a processor may be stored. Examples include random access memory (RAM), read-only memory (ROM), volatile memory, nonvolatile memory, hard drives, CD ROMs, DVDs, flash drives, disks, and any other known physical storage medium. Singular terms, such as “memory” and “computer-readable storage medium,” may additionally refer to multiple structures, such a plurality of memories and/or computer-readable storage mediums. As referred to herein, a “memory” may comprise any type of computer-readable storage medium unless otherwise specified. A computer-readable storage medium may store instructions for execution by a processor, including instructions for causing the processor to perform steps or stages consistent with an embodiment herein. Additionally, one or more computer-readable storage mediums may be utilized in implementing a computer-implemented method. The term “computer-readable storage medium” should be understood to exclude carrier waves and transitory signals.

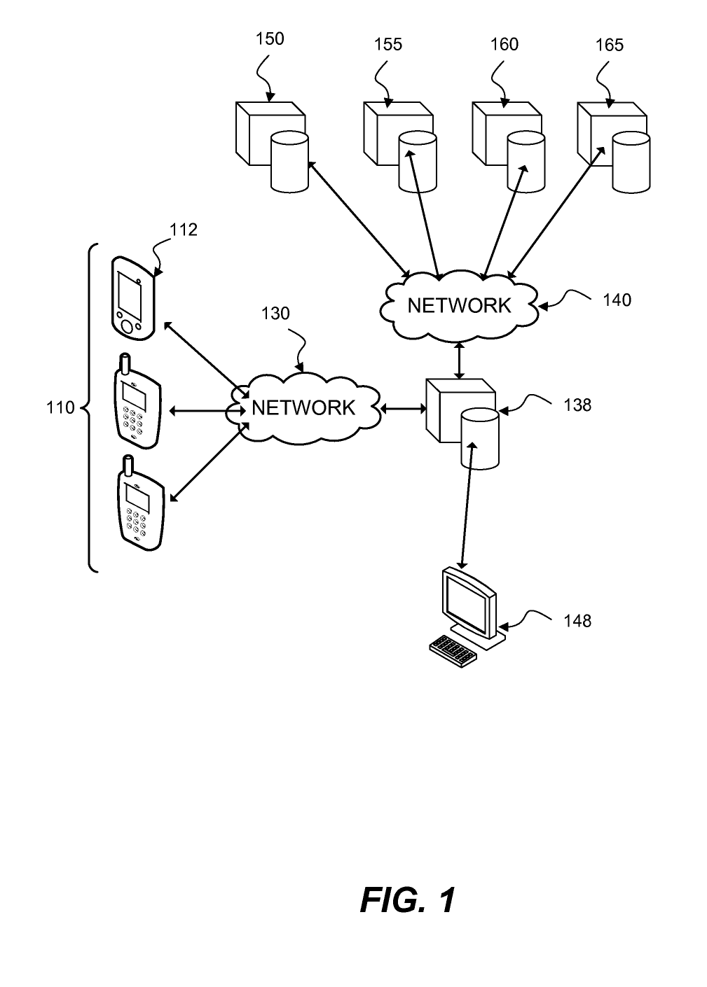

Turning to FIG. 1, an exemplary system that facilitates clinical trial compliance is illustrated, in accordance with an embodiment. A plurality of different mobile communications devices 110, each associated with a different participant, may access a documentation sever 138 over a network 130 in order to provide clinical trial information to the documentation server 138. As used herein, the term mobile communications device includes cellular phones, smart phones, iPads, and other handheld devices having a processor and a memory and capable of wirelessly communicating with a server.

Each of the mobile communications devices 110 contains a processor that executes instructions to run a clinical trial application. The clinical trial application allows the participant to perform various tasks associated with the clinical trial on a mobile communications device. These tasks, which are discussed in more detail below, may include gathering documentation of study medication compliance via video, issuing reminders to take study medication at prescribed dosage intervals, facilitating serious adverse event (SAE) notification, capturing diary and symptom scale data electronically, scheduling other clinical-trial-related reminders for the participant (e.g., physician visits or adjustments to the health intervention administration schedule), and transmitting compliance and diary information wirelessly to the documentation server 138, which can include a secure database.

Each mobile communications device 110 also includes a camera or accessory for recording video.

The network 130 may be a cellular network or some other type of network, including the Internet, that allows the mobile communications device 110 to remotely connect to the documentation server 138. The connection may be a secure connection that utilizes certificate tokens, encryption, virtual private networks, and other known technology. The exchange of information may be facilitated by the mobile communications device sending an email and/or MMS message to the documentation server in one embodiment. In another embodiment, the communication can include one or more remote procedure calls made between the mobile communications device 112 and documentation server 138.

The documentation server 138 may comprise at least one processor that executes instructions to perform stages related to facilitating a clinical trial. The documentation server 138 may also include a database, which can be implemented on one or more non-transitory computer-readable mediums. Additionally, the documentation server may include an interface for receiving clinical-trial-related video clips, SAE notifications, and questionnaire answers from the mobile communications devices 110. (For the purposes of this disclosure, a symptoms score is one type of questionnaire answer.) The interface may be driven by an application in one embodiment, allowing the documentation server to make procedure calls to the mobile communications devices 110 and/or place telephone calls to the mobile communications devices (e.g., to remind the participants of scheduled clinical-trial-related events or requirements). Likewise, in accordance with one aspect, the mobile communications devices 110 may make procedure calls to the documentation server 138, for example, to initiate video upload, report an SAE, update dosage schedules, download a questionnaire, etc.

At least one supervisory user (e.g., clinical trial administrator, doctor, study supervisor, and/or authorized clinical trial sponsor) can access the clinical trial data stored in the database by the documentation server 138 through user of a supervisory computer terminal 148. The computer terminal 148 can be any known type of computer, server, and/or mobile communications device and may be connected locally (e.g., over a local area network) to the documentation server 138 in one embodiment. Alternatively, the supervisory computer terminal 148 may connect remotely to the documentation server 138 in another embodiment.

Additionally, the documentation server 138 may contact a plurality of other entities 150, 155, 156, and/or 165 to report an SAE received from mobile communications device 112, in one embodiment. These entities can include, for example, the clinical trial study center, a doctor's office, the sponsor pharmaceutical company, and the Federal Drug Administration (FDA). These entities may be contacted over network 140, which is not necessarily the same as network 130, but may be the same in one embodiment.

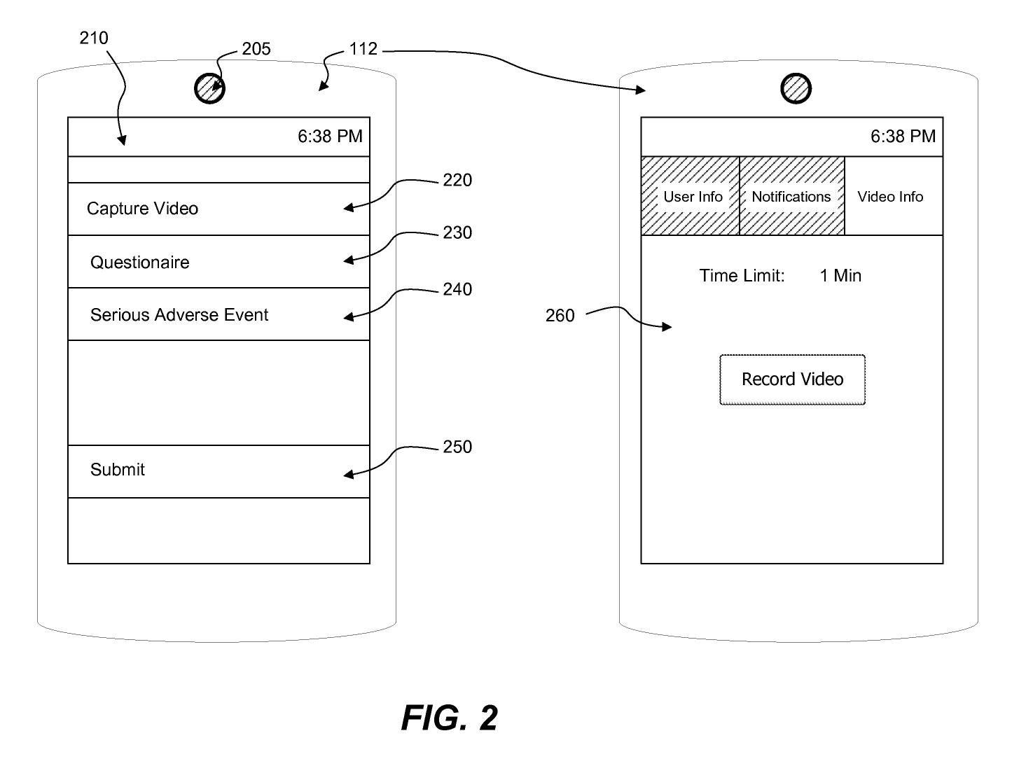

FIG. 2 is an exemplary illustration of screens 210 and 260 generated on a mobile communications device 112 when the processor executes the clinical trial application, in accordance with an embodiment. The interface layout and functionality provided by the clinical trial application can vary among embodiments.

In one aspect, the application is pre-installed on a set of mobile communications devices that are provided by a third party vendor to the participants of the clinical trial. The third party vendor may be the same entity that maintains the documentation server, or some other entity. In another embodiment, the third party vendor installs the application on mobile communications devices that belong to the participants.

In another aspect, the clinical trial application may be downloaded by the mobile communications devices 110 from a download server, which may or may not be part of the documentation server 138. The download server may verify that the requesting mobile communications device 112 is associated with a participant in a clinical trial. Additionally, the clinical trial application may be customized differently for each clinical trial. Therefore, the download server may contain several different versions of the clinical trial application and provide the version that is specifically tailored for the particular participant and/or clinical trial.

In another embodiment, the clinical trial application is provided on disk and loaded onto the mobile communications device directly or by connecting the mobile communications device to a computer.

Continuing with FIG. 2, the mobile communications device 112 in this example executes the clinical trial application to display a main screen 210. The main screen 210 may contain a first option 220 for capturing video of the participant administering a health intervention, a second option 230 for answering a questionnaire, and a third option 240 for reporting a serious adverse event (SAE) 240. An option 250 to submit clinical trial documentation to the documentation server 138 may also be provided in one embodiment. One or more of these options may make use of camera 205 to document compliance with requirements of the clinical trial. With these and other options, the clinical trial application may uniquely provide health intervention compliance, SAE reporting, study subject medication reminder, study subject symptom assessments and diary data for transmission via the mobile communications device 112.

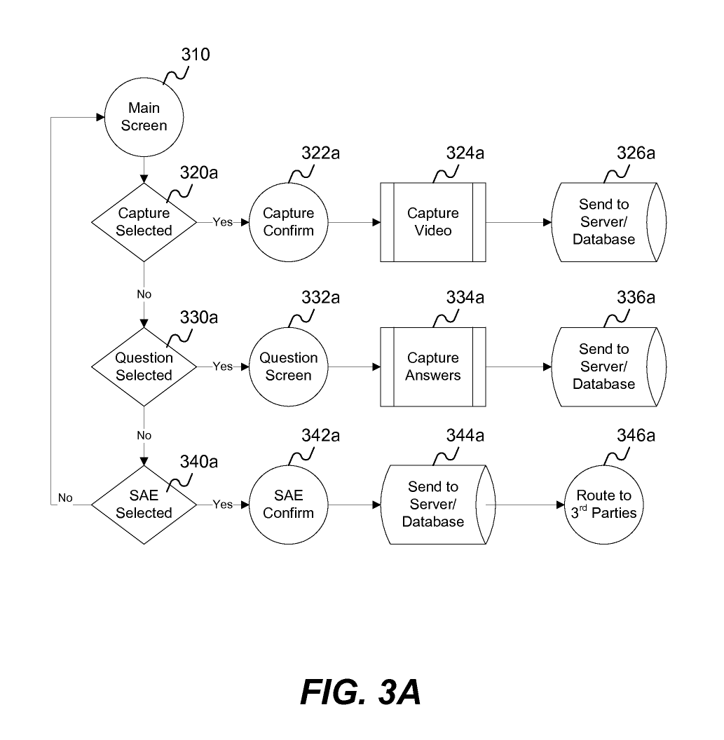

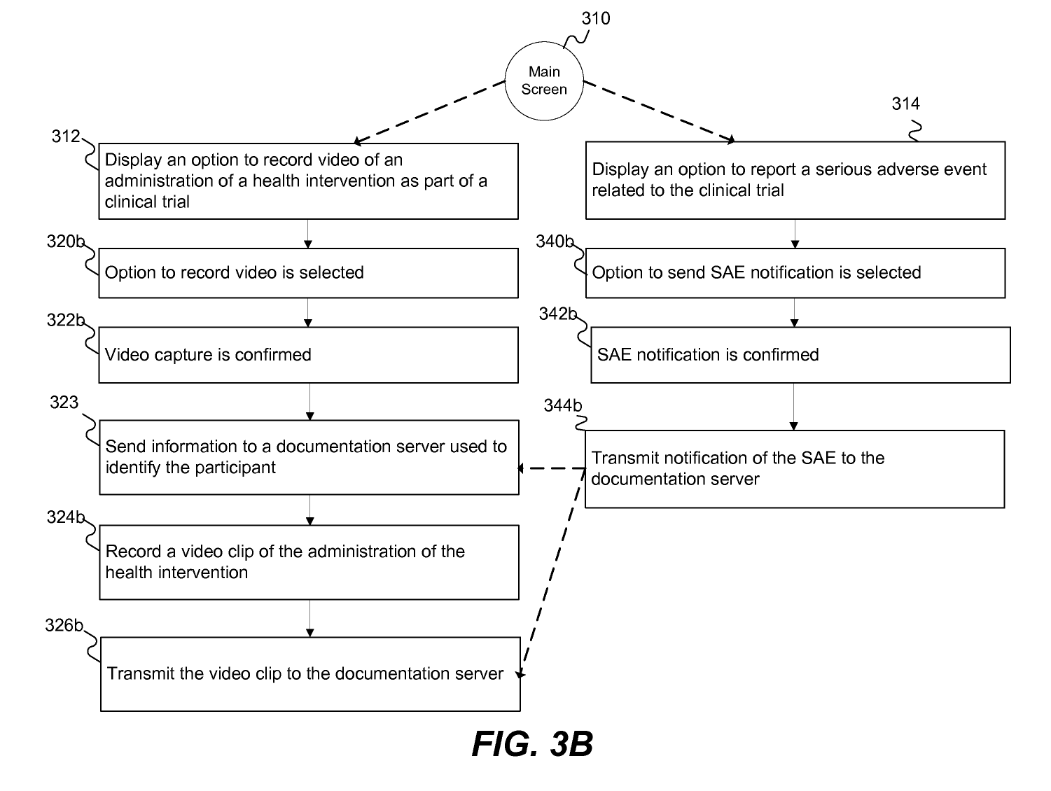

As companions to FIG. 2, FIGS. 3A and 3B are exemplary flow charts with non-exhaustive listings of steps that may be performed by a mobile communications device, in accordance with an embodiment. FIG. 3A is a simplified flow chart of exemplary steps that may occur when the user selects one of the options 220, 230, or 240 of the main screen 210, and is provided. FIG. 3B includes similar steps, denoted with a “b” after the corresponding reference number, and additional exemplary steps performed by the mobile communications device 112. Although FIG. 3B will be discussed with regard to the video capture option 220 and the SAE notification option 240, FIG. 3A is nevertheless provided for a simplified and convenient overview.

Turning now to FIG. 3B, the process of capturing video showing compliance is discussed. At step 310, main screen 210 may be displayed.

At step 312, the mobile communications device displays an option to record video of an administration of a health intervention as part of a clinical trial. In one embodiment, the main screen 210 always displays this option. Alternatively, the application may hide the video capture option 220 until it is appropriate to administer the health intervention. For example, the clinical trial application may be programmable to alarm at intervals to remind participants to take their medication. At these intervals, the video capture option 220 may be presented at step 312. The video capture option 220 may then remain available until it has been used. Then, once the video clip is transmitted at step 326b, the option to record video 220 may once again be hidden until the next scheduled administration time occurs. Hiding option 220 between doses can reduce the likelihood of the participant administering the health intervention ahead of schedule, or mistakenly selecting the option to record video 220 (e.g., via “pocket dialing”).

At step 320b, the option to record video is selected. Selecting an option can be accomplished by use of a touch screen, soft keys, or any other known method of selecting a function or option using a mobile communications device.

In one embodiment, after the video capture option 220 is selected, a capture confirmation screen 260 may be displayed at step 322b. The capture confirmation screen 260 may include password entry to ensure that video clips are not recorded inadvertently, or to verify the participant's identity (i.e., identity code).

The capture confirmation screen 260 may also present (or allow the participant to access) additional information, such as the maximum recording length (e.g., “1 min”). In one embodiment, the documentation server 138 sets the maximum recording length and/or other variables commiserate with the amount of time expected to complete the administration of the health intervention or space restrictions in the database. The confirmation screen 260 may also display information relative to a date and/or time stamp that will be placed on the video clip. Further, the confirmation screen 260 may notify the user of a particular dosage (i.e., administration) that database will associate with the video clip to make sure that the participant is in synch with the database (i.e., documentation server 138).

At step 323, the mobile communications device may communicate with the documentation server 138 to identify the participant. The mobile communications device 112 may provide an identifier (e.g., a phone number and/or a password) to the documentation server 138 that is used to identify the participant. In one embodiment, this step occurs as part of step 322b. Alternatively, the identifier may be part of the transmission of the video clip at step 326b.

The identifier may allow the documentation server 138 to not only identify the participant, but also verify that the participant should be administering the health intervention at the present time. If no administration is scheduled, the documentation server 138 may send a message to the mobile communications device 112, alerting the participant that the health intervention should not presently be administered. Even if no administration is scheduled, the mobile communications device 112 may still allow the participant to create a video clip in one embodiment, so that the participant's activities can be fully documented.

In another embodiment, the identifier from the mobile communications device 112 may include additional information, such as a time stamp and/or administration identifier that allows the documentation server to associate the downloaded documentation information (e.g., video clip) with a particular administration of the health intervention by the patient. This may allow, for example, a supervisory user to review a particular video clip for a particular dosage of medication by a particular participant, through use of information retrieval tools provided by the application on the documentation server 138 or supervisory terminal 148.

At step 324b, a video clip of the participant administering the health intervention is recorded. The camera 205 may be used to record the video clip. In one embodiment, the clinical trial application may utilize a pre-existing camera application and/or module to use camera 205 in creating the video clip.

At step 326b, the mobile communications device 112 transmits the video clip to the documentation server 138 over network 130. The transmission of the video clip can occur automatically after the recording is complete in one embodiment. In another embodiment, the transmission of the video clip is initiated after the participant selects an option to submit clinical trial documentation, such as the submit button 250 of FIG. 2. For example, pressing submit 250 may cause all of the outstanding video clips, questionnaire answers, and/or SAE notifications to be transferred to the documentation server during a single transaction.

In another embodiment, the mobile communications device 112 contacts the documentation server 138 (or vice versa) without human intervention at some later point in time to initiate the transmission of clinical trial documentation (including the video clip). In this way, clinical trial documentation collected on a mobile communications device 112 may be up uploaded to the documentation server 138 on an as-available basis. This may allow, for example, a participant to make a video recording of themselves administering a health intervention, even when they do not currently have poor phone and/or network reception. Then, once the reception is improved, the documentation may be uploaded. Similarly, if only a first portion of the clinical trial documentation (e.g., questionnaire answers) is uploaded from the mobile communications device 112 when a loss in communication occurs, a second portion (e.g., video clip) can be uploaded at a later time.

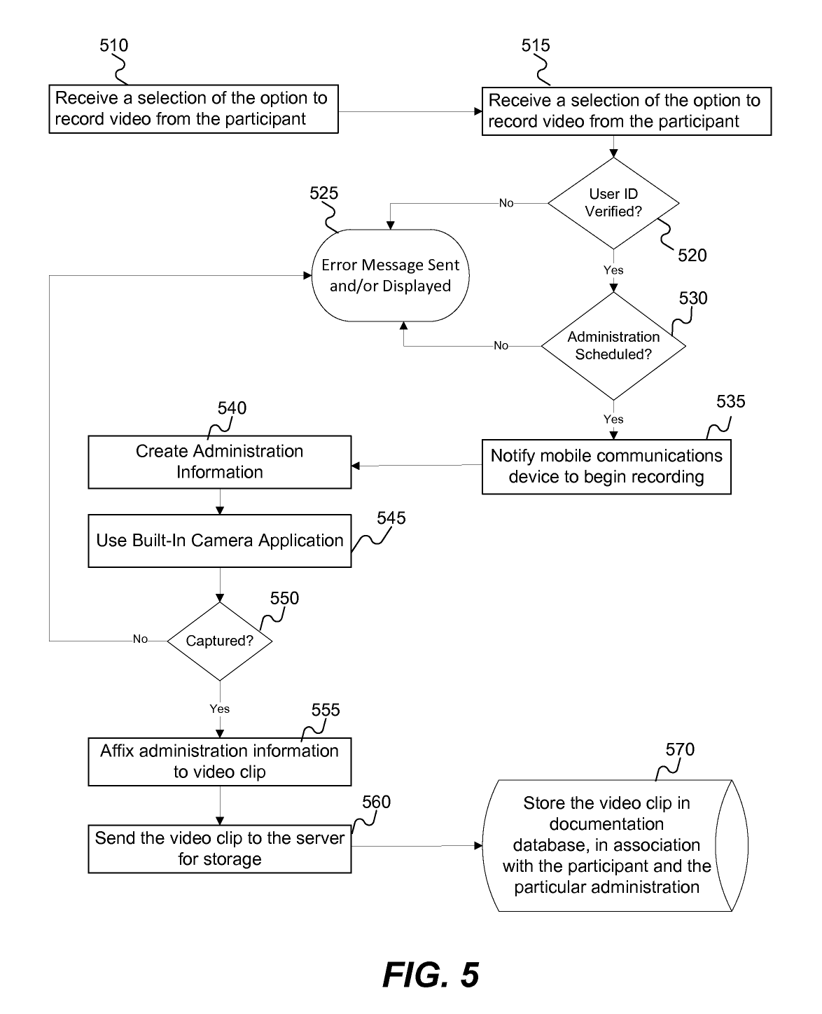

The video capture process may also include other steps, some of which are discussed with reference to FIG. 5, below.

Next, an exemplary process for reporting a serious adverse event (SAE) is discussed. Continuing with FIG. 3B, at step 314 an option 240 to report an SAE is displayed. In one embodiment, this option 240 is always displayed since it is unpredictable when an SAE may occur. After this option 240 is selected at 340b, a confirmation screen may be shown at step 342b. This screen may function similarly to the capture confirmation screen 260, preventing inadvertent SAE notifications. However, in one embodiment, no confirmation screen is presented. Instead, the clinical trial application may cause the mobile communications device 112 to notify the study center and the sponsor drug company's safety committee when a participant experiences an SAE with one touch of the screen.

The SAE confirmation screen might additionally present checkbox options for the participant to select when reporting the SAE. This may allow the documentation server 138 to provide additional information to some of the entities that are notified of the serious adverse SAE. In another embodiment, the video camera is activated to record a short video clip of the participant describing the SAE, or visually documenting a physical effect of the event. The SAE notification may be sent automatically, along with the video, after a brief period of recording has elapsed. The video clip may, for example, be routed to a doctor's office or to an individual associated with the clinical trial so that the severity of the SAE can be quickly and individually examined.

At step 344b, the mobile communications device 112 wirelessly sends notification of the SAE, by transmitting information to the documentation server. Like with step 326b, this information may include an identifier (e.g., phone number and/or password) that may be use to identify the patient experiencing the SAE. Transmission may also include the phone number of a personal emergency contact, in one embodiment. In another embodiment, a video clip of the SAE and/or the video clip of the administration of the health intervention preceding the SAE may be transmitted with the SAE notification.

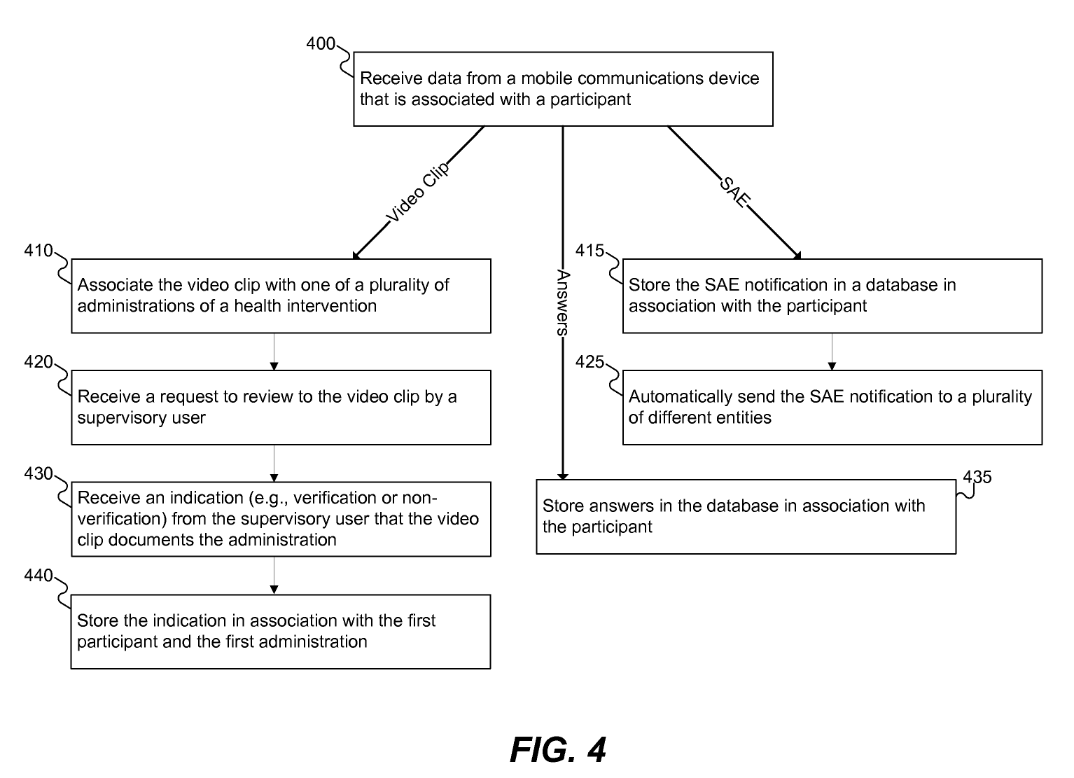

The documentation server 138 may use the identifier to further rout to the SAE notice to the appropriate entities, as discussed later with respect to FIG. 4 and as indicated in step 346 of FIG. 3A.

The questionnaire functionality will now be briefly discussed. Returning again to FIG. 3A, when the questionnaire option 230 is selected at step 330, one or more questions is presented at step 332a. The questionnaire may streamline the diary entry process that has been time consuming and inconvenient in prior systems. For example, respiratory symptoms, shortness of breath scales, depression scales, depression questionnaires, activities of daily living scales and other diaries and questionnaires may be required to assess effectiveness of study medications. The participant process is simplified in one embodiment, as the participant may touch the diary application on the mobile communications device, complete the desired questions, and touch send.

At step 334a, answers to the questions are captured. For example, the participant may select multiple choice answers by touching applicable responses, or may type answers in one embodiment. In another embodiment, the participant gives answers verbally, which are recorded into a video clip or audio file by the mobile communications device.

At step 336a, the answers may be transmitted to the documentation server 138. This transmission may occur, for example, as previously described for video clips. In one embodiment, the answers are immediately transmitted as soon as they are received from the participant.

Turning now to the functionality of the documentation server 138, FIG. 4 is an exemplary flow chart with a non-exhaustive listing of steps that may be performed by a documentation server in handling clinical trial documentation received from the mobile communications device, in accordance with an embodiment. As discussed with respect to FIG. 1, the documentation server 138 can communicate with a plurality of mobile communications devices 110, including mobile communications device 112. In addition, the documentation server 138 can provide backend functionality, such as the storage of the clinical trial data in a database. The documentation server 138 can also provide an interface to one or more supervisory users for reviewing the collected documentation, and for reporting various alerts, schedules, and other notifications to the mobile communications devices 110 and other entities (e.g., 150, 155, 160, and 165).

At step 400, the documentation server 138 may receive data from a mobile communications device 112 that is associated with a participant. As previously discussed, this data can include one or more video clips, answers, and/or a notification of a SAE. Receiving the data can be triggered by the mobile communications device 112 in one embodiment. In another embodiment, the documentation server 138 may initiate the transmission of the data (e.g., video clip). For example, the documentation server, in one aspect, may make at least one remote procedure call that is recognized by the clinical trial application, which may remain executing on the mobile communications device 112 even when the participant is not it. Remote procedure calls may, for example, allow the documentation server 138 to inspect mobile communications device 112, for example, to determine whether clinical trial documentation (e.g., video clips, SAE notifications, questionnaire answers, and/or diary entries) exists on the mobile communications device 112 that has not yet been uploaded to the documentation server 138. If such information exists, then the documentation server 138 can cause the mobile communications device 112 to automatically upload that information.

At step 410, in the case of a video clip, the documentation server may associate the video clip with a particular administration from amongst a plurality of scheduled administrations of the health intervention. This may include utilizing the identifier (e.g., phone number and/or password) to identify the participant. In one embodiment, the identifier may also allow the documentation server 138 to identify the clinical trial or correct database to use.

Using the participant's identifier and/or identity code, the database may locate table entries that indicate the administration schedule for the patient. In one embodiment, the database tracks which administrations (e.g., dosages) have already occurred, and the available administration closest to a time stamp associated with the video clip can be determined as the one of the plurality of administrations with which to associate the video clip. The video clip may then be stored in the database, with table entries linking the video clip to the participant and, in one embodiment, also to the particular administration within the plurality of scheduled administrations for that participant. Other forms of documentation information (e.g., SAE notifications, participant answers, etc.) may also be stored in this manner.

For auditing purposes, or to meet the requirements of the FDA, at step 420 the documentation server may receive a request to review the video clip by a supervisory user (e.g., study center employee). A user interface on supervisory terminal 148 may be used in making this request. In response, the documentation server 138 may provide the supervisory user with the video clip and/or play the video clip within the user interface. If the supervisory user determines that the video clip sufficiently shows the participant administered the health intervention, then, in one embodiment, the supervisory user submits an indication verifying the sufficiency of the video clip. Alternatively, the supervisory user may submit an indication that the video clip does not sufficiently show the administration of the health intervention.

At step 430, the documentation server may receive the indication (e.g., verification or non-verification) from the supervisory user. If the indication does not verify the contents of the video clip, the documentation server may automatically send a notification to the participant so that the administrations may be properly documented in the future.

At step 440, the documentation server may store the indication in the database, in association with the particular participant and administration in the database. This allows for compliance with FDA guidelines requesting the use available electronic means to more closely monitor participant compliance during clinical trials. Additionally, auditing of this compliance can be streamlined by, for example, running a report that shows which supervisory user visually reviewed each administration, when the review occurred, and/or when the administration occurred. In one embodiment, an electronic report can include links to each administration, so that an auditing entity can view the video of any given administration at a later time.

If the data received from the mobile communications device 112 is a serious adverse event (SAE) notification, at step 415 the documentation server may store the SAE notification in a database in association with the participant. The SAE may be associated with the correct participant using an identifier, as previously disclosed.

At step 425, the documentation server 138 may send the SAE notification to a plurality of different entities. The documentation server 138 may determine these entities by accessing the database and, based on the participant identification, retrieving information regarding the appropriate entities to which to forward the notification. In one embodiment, the retrieved information may include the specific contact methods needed to contact and/or connect to each of those entities 150, 155, 160. For example, entity 150 may be a server at the study center for the clinical trial, which the documentation server 138 connects to securely over network 140. Entity 155 may be a doctor's office, which the documentation server 138 calls and leaves an automated voice message. Entity 160 may be the sponsor pharmaceutical company and entity 165 may be the Federal Drug Administration, both of which can be notified with pre-determined protocols that may be retrieved from the database. This process may streamline the reporting of SAEs to various entities, ensuring that SAE reporting meets the requirements of the clinical trial and the guidelines set forth by the FDA.

In one embodiment, the SAE notification may additionally trigger the documentation server to call a personal emergency contact specified by the participant. In one embodiment, this emergency contact is retrieved from the database. In another embodiment, the application on the mobile communications device may allow the participant to enter an emergency contact, and when the SAE notification is generated, the emergency contact information is sent along with the notification. This contact number may be used by the documentation server 138 to place a pre-recorded phone call to that phone number. The pre-recorded phone call can also give an indication of what the SAE entails, in one embodiment, based on selections the participant made on the SAE confirmation screen.

If the data received from the mobile communications device 112 comprises answers to a questionnaire, at step 435 the documentation server may store the answers in a database in association with the participant. The answers may be associated with the correct participant using an identifier, as previously disclosed.

FIG. 5 is an exemplary flow chart with a non-exhaustive listing of steps that may be performed between the mobile communications device and the documentation server to record and store video clips of a participant complying with a requirement of the clinical trial (e.g., administering a health intervention), in accordance with an embodiment. In general, the steps on the left hand side of FIG. 5 may be performed by the mobile communications device 112 and the steps on the right hand side may be performed by the documentation server 138.

At step 510, the mobile communications device 112 may receive a selection of the option to record video from the participant.

At step 515, the documentation server receives an identifier from the mobile communications device.

At step 520, the identity code of the participant is verified by the documentation server by using the identifier to compare against participant records in a database. (The identity code may be used in place of the participant's actual identity to comply with privacy requirements.) This may include determining which clinical trial the participant belongs to.

If the identity code of the participant cannot be verified, at step 525 an error message is sent to the mobile communications device for display.

If the identity code of the participant is verified, then at step 530, the documentation server checks the database to determine whether the patient is scheduled to fulfill the requirement (e.g., administer the health intervention) at the present time.

If an administration is not due to be administered, the administration server sends an error message to notify the participant that an administration is not currently scheduled at step 525.

If an administration is currently scheduled for the participant, at step 535 the documentation server 138 may notify the mobile communications device to begin recording.

In response, the mobile communications device 112 may create administration information at step 540. The administration information can include a time stamp, participant identifier, or administration (i.e., dosage) identifier to be affixed to and/or transmitted with the video clip. In one embodiment, this information is prepared and/or transmitted at step 515.

At step 540, the mobile communications device uses the mobile communications device's camera application to record the video clip.

At step 550, the application determines whether the video clip was successfully captured. This may include, in one embodiment, prompting the participant to accept or reject the recording.

At step 555, if the video clip is successfully captured, the mobile communications device may affix the administration information to the video clip. This can include visually stamping the video clip so that the administration information is displayed when the video clip plays. In another embodiment, the affixation can include including the administration information as part of the metadata for the video clip.

At step 560, the mobile communications device 112 sends the video to the documentation server 138 for storage (e.g., in the database).

At step 570, the documentation server 138 stores the video clip in the database in association with the participant and the particular administration. This can include associating the video with a patient identifier in a table of the database. Similarly, the video clip can be associated with an administration identifier within the database.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for facilitating clinical trial documentation, the system comprising:
a database including a non-transitory storage medium for storing clinical trial data; and
a processor in communication with the database, the processor executing instruction to perform stages comprising:
receiving, from a mobile communications device, a video clip of a participant administering a health intervention as part of a clinical trial;
associating the video clip with the participant by identifying the participant from amongst a plurality of participants based on an identifier received from the mobile communications device;
storing the video clip in the database in association with the first participant and the first administration; and
providing the video clip to a supervisory user to verify that the participant has complied with a requirement of the clinical trial.

2. The system of claim 1, wherein the processor further performs stages comprising:
associating the video clip with a first administration of the health intervention from amongst a plurality of scheduled administrations of the health intervention;
associating the video clip with a first clinical trial from amongst a plurality of clinical trials; and
storing the video clip in the database in association with the first administration and first clinical trial.

3. The system of claim 1, wherein providing the video clip to a supervisory user comprises:
receiving a request to review the first video by the supervisory user;
receiving an indication from the supervisory user of whether the first video adequately documents the first administration by the participant; and
storing the indication in the database in association with the video clip.

4. The system of claim 1, wherein the processor further performs stages comprising:
determining that a time period has passed for a receiving a second video clip of a second administration of the health intervention; and
sending the participant a reminder to submit the second video clip of the second administration of the health intervention.

5. The system of claim 1, wherein the processor further performs stages comprising:
detecting that a time period for receiving a second video clip has passed; and
issuing a remote procedure call to the mobile communications device to initiate transmission of the second video clip;
receiving the second video clip;
storing the second video clip in the database in association with the participant.

6. The system of claim 1, wherein the processor further performs stages comprising:
receiving, from the mobile communications device, a notification of a serious adverse event;
storing the notification of the serious adverse event in the database;
identifying a plurality of entities to receive the notification of the serious adverse event; and
automatically sending the notification of the serious adverse event to the plurality of entities.

7. The system of claim 6, wherein the processor further performs stages comprising, for each identified entity, identifying a contact method for the identified entity, wherein the respective identified contact methods are used for automatically sending the notification of the serious adverse event to the plurality of entities.

8. The system of claim 6, wherein the plurality of locations include a study center and a location associated with the Federal Drug Association.

9. A non-transitory computer-readable medium containing instructions that, when executed by a processor on a mobile communications device, cause the mobile communications device to perform steps including:
display, on a screen of the mobile communications device:
a first option to record video of an administration of a health intervention as part of a clinical trial;
a second option to report a serious adverse event related to the clinical trial; and
a third option to answer questions related to the clinical trial;
receive a selection of the first option;
record a video clip of the administration of the health intervention;
connect to a documentation server that receives a plurality of video clips from a plurality of participants in the clinical trial; and
transmit the video clip to the documentation server.

10. The non-transitory computer-readable medium of claim 9, the steps further comprising:
receive a selection of the second option; and
report the serious adverse event to the documentation server.

11. The non-transitory computer-readable medium of claim 9, wherein the processor further causes the mobile communications device to transmit, during a single transmission, a video clip along with answers generated in response to the third option.

12. A non-transitory computer-readable medium containing instructions that, when executed by a processor on a mobile communications device, cause the mobile communications device to perform steps that include:
displaying, on a screen of the mobile communications device, an option to record video documenting a participant's compliance with a requirement of a clinical trial;
receiving a selection of the option to record video;
recording a video clip, using a camera component of the mobile communications device, of a participant complying with the requirement;
wirelessly transmitting an identifier to the documentation server that the documentation server can use to identify the participant; and
wirelessly transmitting the video clip to the documentation server for storage in a database in association with the identified participant.

13. The non-transitory computer-readable medium of claim 12, wherein the requirement includes administering a health intervention on an administration schedule.

14. The non-transitory computer-readable medium of claim 12, wherein the steps further include verifying that the participant is scheduled to comply with the requirement at the present time before recording the video clip, wherein the verification includes connecting to the documentation server and receiving authorization from the documentation server to perform the administration.

15. The non-transitory computer-readable medium of claim 12, wherein the steps further include:
displaying, on the screen, an option to report a serious adverse event;
receiving a selection of the option to report the serious adverse event; and
reporting the serious adverse event to the documentation server, wherein the reporting includes data indicating the serious adverse event and an identifier that allows the documentation server to report the serious adverse event to a plurality of sources.

16. The non-transitory computer-readable medium of claim 12, wherein the steps further include:
receiving an administration schedule from the pre-defined server; and
alerting the participant each time an administration of a health intervention is due based on the received administration schedule.

17. The non-transitory computer-readable medium of claim 12, wherein the steps further include receiving an indication on the mobile communications device of whether the video clip was verified by a supervisor user.

18. The non-transitory computer-readable medium of claim 12, wherein the steps further include:
receiving a plurality of questions from the documentation server;
displaying the plurality of questions to the participant;
receiving answers to the questions from the participant; and
wirelessly transmitting the answers to the documentation server for storage.

19. The non-transitory computer-readable medium of claim 18, wherein the steps further include:
receiving a request from the documentation server to send data to the documentation server that the documentation server has not yet received; and
transmitting to the documentation server a plurality of video clips that show the participant attempting to comply with the requirement.

20. The non-transitory computer-readable medium of claim 12, wherein the stages further comprise displaying an option to send data to the documentation server, wherein selection of the option to send data causes a plurality of video clips to be sent to the documentation server that were not previously received by the documentation server.
